(19) United States
(12) Patent Application Publication
(10) Pub. No.: US 2023/0196716 A1
(43) Pub. Date: Jun. 22, 2023

(54) Training multi-target image-text matching model and image-text retrieval

(71) Applicant: BEIJING BAIDU NETCOM SCIENCE TECHNOLOGY CO., LTD., BEIJING (CN)

(72) Inventors: Yuan FENG, Beijing (CN); Zhun SUN, Beijing (CN); Honghui ZHENG, Beijing (CN); Ying XIN, Beijing (CN); Bin ZHANG, Beijing (CN); Chao LI, Beijing (CN); Yunhao WANG, Beijing (CN); Shumin HAN, Beijing (CN)

(21) Appl. No.: 18/173,689

(22) Filed: Feb. 23, 2023

(30) Foreign Application Priority Data
Mar. 2, 2022 (CN) 202210200250.4

(51) Int. Cl. G06V 10/44; G06V 10/774; G06V 10/764

(52) U.S. Cl. CPC G06V 10/443; G06V 10/774; G06V 10/764

(57) ABSTRACT

A method for training a multi-target image-text matching model and an image-text retrieval method are provided. The method for training the multi-target image-text matching model includes: obtaining a plurality of training samples that include sample pairs each including a sample image and a sample text, the sample image including a plurality of targets; obtaining, for each of the plurality of training samples, a heat map corresponding to the sample text in the training sample, the heat map representing a region of the target in the sample image that corresponds to the sample text; and training an image-text matching model based on a plurality of the sample texts and corresponding heat maps to obtain the multi-target image-text matching model.

### CROSS REFERENCE TO RELATED APPLICATIONS

This application claims priority to Chinese Patent Application No. 202210200250.4, filed on Mar. 2, 2022, the contents of which are hereby incorporated by reference in their entirety for all purposes.

### TECHNICAL FIELD

The present disclosure relates to the technical field of artificial intelligence, and in particular to the technical filed of deep learning and image recognition.

### BACKGROUND

With the continuous development of the Internet, multimedia data shows explosive growth. It has become a hot topic at present how to effectively organize, manage and retrieve these large-scale multimedia data. For multimedia data, since multi-modal information such as text and image is in a heterogeneous feature space and the relationship between them is complex and diverse, how to implement cross-modal information retrieval has become a problem to be solved.

At present, for cross-modal information retrieval, when there is a plurality of targets in an image, it is easy to cause the problem of multi-target confusion, which affects the accuracy of retrieval results.

### SUMMARY

The present disclosure provides a method and an apparatus for training a multi-target image-text matching model, and an image-text retrieval method and apparatus.

According to an aspect of the present disclosure, a method for training a multi-target image-text matching model is provided, which includes:

obtaining a plurality of training samples, wherein the training samples include sample pairs each including a sample image and a sample text, and the sample image includes a plurality of targets;

obtaining, for each training sample, a heat map corresponding to the sample text in the training sample, wherein the heat map represents a region of the target in the sample image that corresponds to the sample text; and training an image-text matching model based on a plurality of the sample texts and corresponding heat maps to obtain the multi-target image-text matching model.

According to an aspect of the present disclosure, an image-text retrieval method is provided, which includes:

obtaining a retrieval text and a plurality of images;

inputting the retrieval text and the plurality of images to a multi-target image-text matching model to obtain similarities between the retrieval text and the plurality of images; and

determining a target image corresponding to the retrieval text according to the similarities between the retrieval text and the plurality of images,

wherein the multi-target image-text matching model is trained with the method for training a multi-target image-text matching model according to the embodiments of the present disclosure.

According to an aspect of the present disclosure, an electronic device is provided, including:

at least one processor; and

a memory in communicative connection with the at least one processor; wherein

the memory stores instructions executable by the at least one processor that, when executed by the at least one processor, cause the at least one processor to perform the method of any of the embodiments of the present disclosure.

According to another aspect of the present disclosure, there is provided a non-transitory computer-readable storage medium storing computer instructions, the computer instructions executed to cause a computer to perform the method of any of the embodiments of the present disclosure.

The present disclosure provides a method and an apparatus for training a multi-target image-text matching model, an image-text retrieval method and apparatus, an electronic device, and a storage medium. A plurality of training samples is obtained, wherein the training samples include sample pairs each including a sample image and a sample text, and the sample image includes a plurality of targets. For each training sample, a heat map corresponding to the sample text in the training sample is obtained, wherein the heat map represents a region of the target in the sample image that corresponds to the sample text. An image-text matching model is trained based on a plurality of the sample texts and corresponding heat maps to obtain the multi-target image-text matching model. In the technical solution of the present disclosure, the problem of an inaccurate calculation result when there is a plurality of targets in an image may be solved by training the multi-target image-text matching model with the sample text and the corresponding heat map. Applying the multi-target image-text matching model to image-text retrieval may improve the accuracy of a retrieval result.

It should be appreciated that the content described in this section is not intended to identify critical or important features of the embodiments of the present disclosure, nor is it intended to limit the scope of the present disclosure. Other features of the present disclosure will be apparent from the following description.

### BRIEF DESCRIPTION OF THE DRAWINGS

The accompanying drawings are used for a better understanding of the solutions and do not limit the present disclosure. In the accompanying drawings:

FIG. 1 is a flowchart of a method for training a multi-target image-text matching model according to an embodiment of the present disclosure;

FIG. 2 is a heat map corresponding to a sample text “dog” according to an embodiment of the present disclosure;

FIG. 3 is a heat map corresponding to a sample text “cat” according to an embodiment of the present disclosure;

FIG. 4 is a flowchart of an image-text retrieval method according to an embodiment of the present disclosure;

FIG. 5 is a schematic diagram of an online retrieval method according to an embodiment of the present disclosure;

FIG. 6 is a schematic diagram of an online retrieval method according to an embodiment of the present disclosure;

FIG. 7 is a schematic diagram of an apparatus for training a multi-target image-text matching model according to an embodiment of the present disclosure;

FIG. 8 is a schematic diagram of an image-text retrieval apparatus according to an embodiment of the present disclosure; and

FIG. 9 is a block diagram of an electronic device for implementing the method for training the multi-target image-text matching model according to an embodiment of the present disclosure.

### DETAILED DESCRIPTION OF EMBODIMENTS

Example embodiments of the present disclosure are described below in combination with the accompanying drawings, where various details of the embodiments of the present disclosure are included to facilitate understanding and should only be considered as examples. Therefore, those of ordinary skill in the art should recognize that various changes and modifications can be made to the embodiments described herein, without departing from the scope and spirit of the present disclosure. Likewise, the description of well-known functions and structures is omitted in the following description for clarity and conciseness.

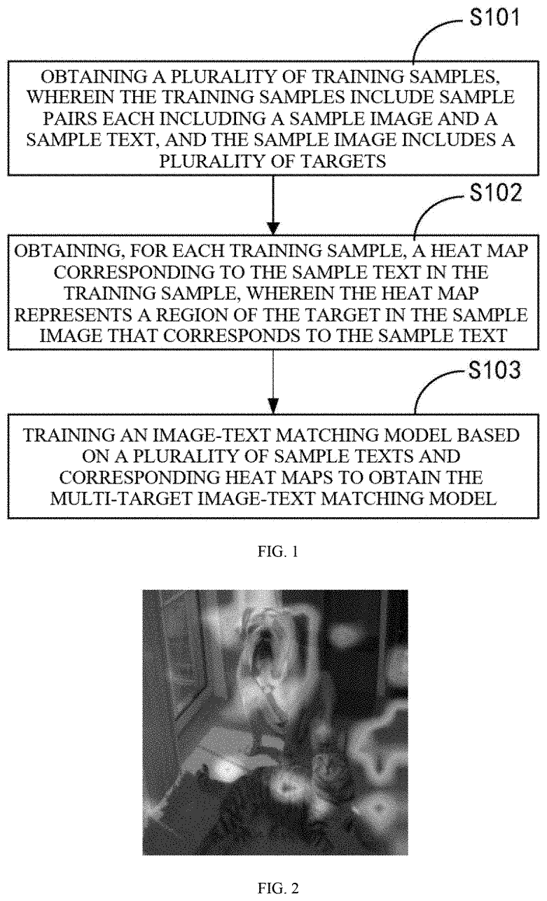

The embodiments of the present disclosure provide a technique for training a multi-target image-text matching model. FIG. 1 is a flowchart of the method for training the multi-target image-text matching model according to an embodiment of the present disclosure. The method may be applied to an apparatus for training the multi-target image-text matching model, and the apparatus may be deployed in a terminal device, a server, or another processing device. In some possible implementations, the method may be also implemented by invoking computer-readable instructions stored in a memory through a processor. As shown in FIG. 1, the method includes:

Step S101, obtaining a plurality of training samples, wherein the training samples include sample pairs each including a sample image and a sample text, and the sample image includes a plurality of targets.

In some implementations, the text and the image corresponding to the text may be obtained as the sample text and the sample image through a web search engine or a web crawler.

The sample image may include a plurality of targets. For example, one sample image may include an image of a cat and an image of a dog, where the sample image and a sample text “cat” constitute a sample pair, and the sample image and a sample text “dog” constitute a sample pair.

Step S102, obtaining, for each training sample, a heat map corresponding to the sample text in the training sample, wherein the heat map represents a region of the target in the sample image that corresponds to the sample text.

The heat map is a visual presentation of data. Data information such as hot spot distribution and region aggregation may be directly reflected by the degree of color change. In the embodiments of the present disclosure, the region of the target in the sample image that corresponds to the sample text is represented by the heat map. Semantic alignment may be implemented in the multi-target image through the heat map, so that the sample text corresponds to the targets in the sample image.

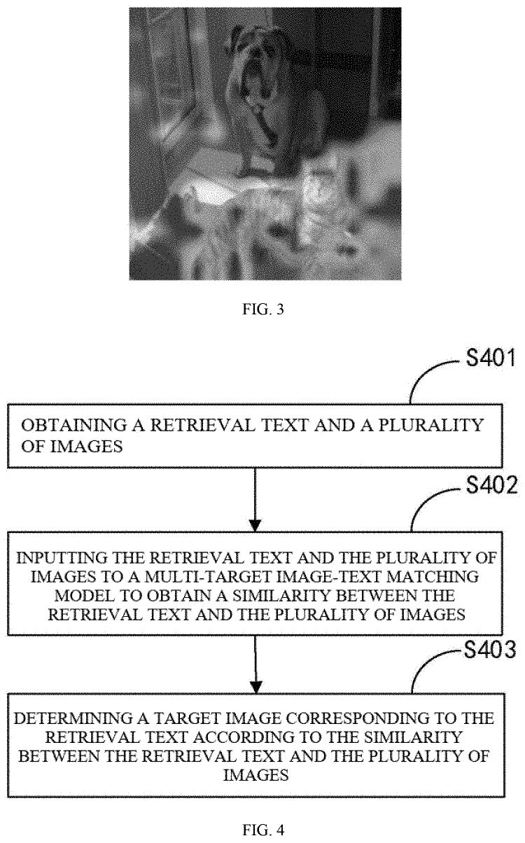

In a sample, the heat map corresponding to the sample text “dog” is shown in FIG. 2, and in FIG. 2, a position of the dog's image is highlighted by color. The heat map corresponding to the sample text “cat” is shown in FIG. 3, and in FIG. 3, a position of the cat's image is highlighted by color.

Step S103, training an image-text matching model based on a plurality of the sample texts and corresponding heat maps to obtain the multi-target image-text matching model.

The sample texts and the corresponding heat maps are used as sample pairs to train the image-text matching model to obtain the multi-target image-text matching model. In the related art, it is easy to cause the problem of multi-target confusion in the image-text matching model when there is a plurality of targets in the image. Compared with the image-text matching model, the multi-target image-text matching model outputs more accurate results.

The present disclosure provides a solution for training a multi-target image-text matching model. A plurality of training samples is obtained, where the training samples include sample pairs each including a sample image and a sample text, and the sample image includes a plurality of targets. For each training sample, a heat map corresponding to the sample text in the training sample is obtained, wherein the heat map represents a region of the target in the sample image that corresponds to the sample text. An image-text matching model is trained based on a plurality of the sample texts and corresponding heat maps to obtain the multi-target image-text matching model. In the technical solution of the present disclosure, the problem of an inaccurate calculation result when there is a plurality of targets in an image may be solved by training the multi-target image-text matching model with the sample text and the corresponding heat map. Applying the multi-target image-text matching model to image-text retrieval may improve the accuracy of a retrieval result.

In a possible implementation, in S102 shown in FIG. 1, obtaining, for each training sample, a heat map corresponding to the sample text in the training sample further includes:

obtaining a pre-trained image-text matching model; and

obtaining, for each training sample, the heat map corresponding to the sample text in the training sample based on the image-text matching model and the training sample.

In some implementations, the image-text matching model may be pre-trained, and the image-text matching model may be a Contrastive Language-Image Pre-training (CLIP) model. The CLIP model includes a text encoder and an image encoder that respectively map the text and the image into a feature space. After an image feature and a text feature of an image-text sample pair are obtained, similarity matric of all images and texts in a batch of samples are calculated, and a loss of similarities between each image and the texts and a loss of similarities between each text and the images are calculated respectively, so that the whole model is optimized after back propagation to finally obtain the image-text matching model. Through the image-text matching model, the heat map corresponding to the sample text in the training sample may be obtained.

In the embodiments of the present disclosure, through the pre-trained image-text matching model, the heat map corresponding to the sample text of each training sample may be obtained.

An implementation process of obtaining the heat map through the pre-trained image-text matching model will be described in the following embodiments.

In a possible implementation, obtaining, for each training sample, the heat map corresponding to the sample text in the training sample based on the image-text matching model and the training sample in the above embodiment further includes:

for each training sample, inputting the training sample to the image-text matching model to obtain a similarity and a gradient that correspond to the training sample; and processing the sample image in the training sample, based on the similarity and the gradient that correspond to the training sample, to obtain the heat map corresponding to the sample text in the training sample.

In some implementations, the similarity and the gradient corresponding to each training sample that are output by the image-text matching model may be obtained by inputting the training sample to the image-text matching model. By processing the sample image with the similarity and the gradient, the heat map corresponding to the sample text is obtained. In some implementations, the heat map may be generated through a gradient-weighted class activation mapping (Grad-Cam) method. Through the Grad-Cam method, response regions in the sample image are different for different sample texts, so that different heat maps may be generated.

In the embodiments of the present disclosure, the heat map corresponding to the sample text is generated based on the similarity and the gradient corresponding to the training sample. By intercepting an energy region of the heat map, interference from the background and other targets may be greatly reduced, thereby generating a more accurate image-text pair.

In a possible implementation, in S103 shown in FIG. 1, training an image-text matching model based on a plurality of the sample texts and corresponding heat maps to obtain the multi-target image-text matching model further includes:

obtaining a pre-trained image-text matching model; and

adjusting model parameters of the image-text matching model based on the plurality of sample texts and corresponding heat maps to obtain the multi-target image-text matching model.

In some implementations, the model parameters of the pre-trained image-text matching model are fine-tuned based on the plurality of sample texts and corresponding heat maps to obtain the multi-target image-text matching model.

In the embodiments of the present disclosure, the model parameters of the pre-trained image-text matching model are fine-tuned. Compared with training the model from the beginning, fine-tuning may save calculation resources and time cost, and improve the efficiency of calculation and the accuracy of calculation results.

In a possible implementation, the image-text matching model in the above embodiment includes a pre-trained text encoder and a pre-trained image encoder.

In the embodiments of the present disclosure, using the pre-trained text encoder and the pre-trained image encoder as parts of the image-text matching model may increase the convergence speed of the model and improve the model effect.

The embodiments of the present disclosure provide an image-text retrieval method. FIG. 4 is a flowchart of an image-text retrieval method according to an embodiment of the present disclosure. The method may be applied to an image-text retrieval apparatus which may be deployed in a server or another processing device. In some possible implementations, the method may be also implemented by invoking computer-readable instructions stored in a memory through a processor. As shown in FIG. 4, the method includes:

Step S401, obtaining a retrieval text and a plurality of images.

In the embodiments of the present disclosure, the executor may be a server. The retrieval text may be a text sent by a terminal device and received by the server, and the plurality of images may be images in a pre-constructed image-text retrieval database. The image-text retrieval database may be a database pre-constructed according to image-text pairs including a plurality of images and texts.

Step S402, inputting the retrieval text and the plurality of images to a multi-target image-text matching model to obtain similarities between the retrieval text and the plurality of images.

The multi-target image-text matching model is trained according to the method for training the multi-target image-text matching model provided in the embodiments of the present disclosure. The retrieval text and the plurality of images are input to the multi-target image-text matching model, and the multi-target image-text matching model outputs the similarities between the retrieval text and each image.

Step S403, determining a target image corresponding to the retrieval text according to the similarities between the retrieval text and the plurality of images.

The similarities between the retrieval text and each image are filtered where an image corresponding to the similarity exceeding a preset threshold is used as the target image corresponding to the retrieval text.

According to the image-text retrieval method provided in the embodiments of the present disclosure, using the pre-trained multi-target image-text matching model to calculate the similarity may solve the problem of an inaccurate calculation result when there is a plurality of targets in an image, and improve the accuracy of a retrieval result.

In a possible implementation, after obtaining the plurality of images in S401 shown in FIG. 4, the method further includes:

extracting an image feature of each of the plurality of images through the image encoder of the multi-target image-text matching model, and classifying the image features of each image to obtain and store images of a plurality of classes.

In some implementations, the multi-target image-text matching model may include the image encoder. After the plurality of images are obtained, the image feature of each of the plurality of images may be extracted and classified through the image encoder. An index is established between the images and belonging classes and is stored in a preset storage space. When the server receives the retrieval text, image-text retrieval is performed based on the index and the retrieval text.

In the embodiments of the present disclosure, performing image feature extraction, classification, and storage in advance may increase the retrieval speed to meet online retrieval requirements.

In a possible implementation, in S402 shown in FIG. 4, inputting the retrieval text and the plurality of images to the multi-target image-text matching model to obtain the similarities between the retrieval text and the plurality of images further includes:

extracting a text feature of the retrieval text through the text encoder of the multi-target image-text matching model;

determining, in the images of the plurality of classes, images of a target class corresponding to the retrieval text; and

obtaining the similarities between the retrieval text and each of the images of the target class through a similarity determination module of the multi-target image-text matching model.

In some implementations, the multi-target image-text matching model may further include the text encoder and the similarity determination module. During image-text retrieval, after the text feature of the retrieval text is extracted through the text encoder, the retrieval text is matched with a corresponding image class. The similarities between the retrieval text and each of the images of the target class is calculated through the similarity determination module of the multi-target image-text matching model.

In the embodiments of the present disclosure, by determining the images of the target class corresponding to the retrieval text and calculating the similarities between the retrieval text and the images of the target class, time waste caused by calculating the similarities between the retrieval text and all the images is avoided and the online retrieval speed is increased.

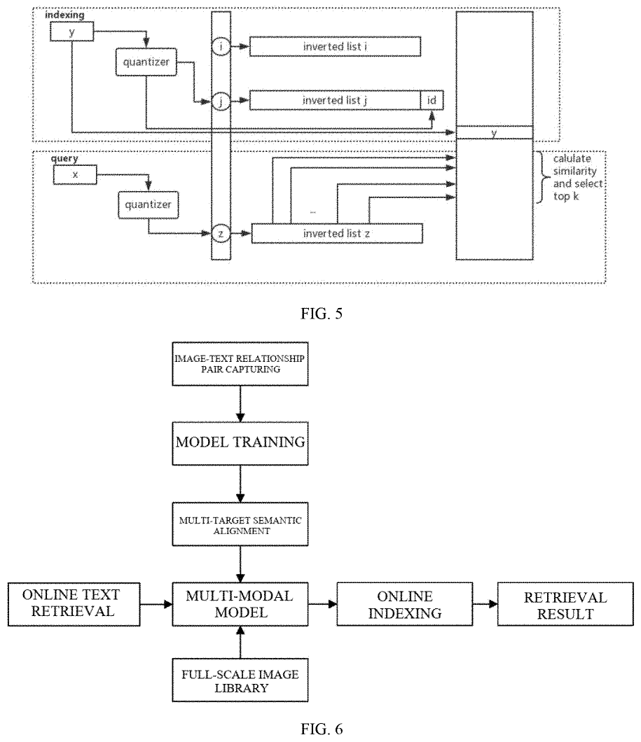

FIG. 5 is a schematic diagram of an online retrieval method according to an embodiment of the present disclosure. A multi-target image-text matching model includes a text encoder, an image encoder, and a similarity determination module. A plurality of images is obtained, and the plurality of images is classified (quantizer as shown in the figure) by extracting image features through the image encoder. As a result, a plurality of classes (i, j, z as shown in the figure) is obtained, and an index is established (indexing as shown in the figure) to obtain inverted index lists (an inverted list i, an inverted list j, . . . , an inverted list z as shown in the figure). The image feature y belongs to a class j, and the inverted list j records an ID of the image feature y. Text features are extracted through the text encoder, obtaining a text feature x of a retrieval text (query as shown in the figure). The image class corresponding to the text feature x is determined as z. The similarities between the text feature x and each image of the image class z are calculated through the similarity determination module, and images with a similarity ranked at top preset positions are determined as a target image set corresponding to the retrieval text (calculate similarity and select top k as shown in the figure).

FIG. 6 is a schematic diagram of an online retrieval method according to an embodiment of the present disclosure. As shown in the figure, the first step is image-text relationship pair capturing. For example, images and texts are obtained through a web crawler and a plurality of image-text relationship pairs are obtained as a training sample set.

The second step is model training. For example, an initial model is trained with the training sample set to obtain an image-text matching model.

The third step is multi-target semantic alignment. For example, a plurality of training samples of the multi-target image-text matching model are obtained, wherein each training sample includes a sample image and a sample text, and the sample image includes a plurality of targets. The training samples are input to the image-text matching model, and a heat map corresponding to the sample text is obtained according to a gradient and a similarity that are output by the image-text matching model.

The fourth step is obtaining a multi-modal model. The multi-modal model, i.e., the multi-target image-text matching model is obtained by fine-tuning the model parameters of the image-text matching model with the sample text and the corresponding heat map.

The fifth step is online text retrieval. For example, a retrieval text is input to the multi-modal model. Images in a full-scale image library are input to the multi-modal model to obtain a plurality of image features. The plurality of image features is classified and indexed. Images of a target class corresponding to the retrieval text are determined, and similarities between the retrieval text and the corresponding images of the target class is calculated, to obtain and output a target image as a retrieval result with a similarity meeting a preset condition.

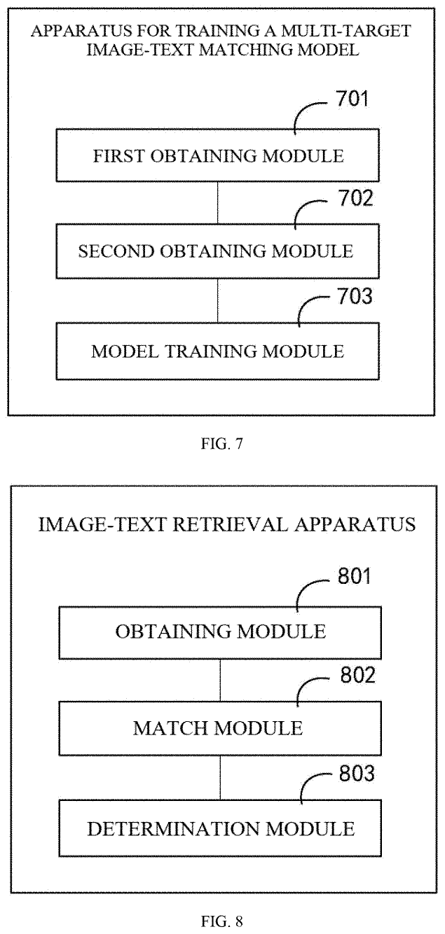

FIG. 7 is a schematic diagram of an apparatus for training a multi-target image-text matching model according to an embodiment of the present disclosure. As shown in FIG. 7, the apparatus for training the multi-target image-text matching model may include:

a first obtaining module 701 configured to obtain a plurality of training samples, wherein the training samples include sample pairs each including a sample image and a sample text, and the sample image includes a plurality of targets;

a second obtaining module 702 configured to obtain, for each training sample, a heat map corresponding to the sample text in the training sample, wherein the heat map represents a region of the target in the sample image that corresponds to the sample text; and

a model training module 703 configured to train an image-text matching model based on a plurality of the sample texts and corresponding heat maps to obtain the multi-target image-text matching model.

The present disclosure provides an apparatus for training a multi-target image-text matching model. A plurality of training samples is obtained, wherein the training samples include sample pairs each including a sample image and a sample text, and the sample image includes a plurality of targets. For each training sample, a heat map corresponding to the sample text in the training sample is obtained, wherein the heat map represents a region of the target in the sample image that corresponds to the sample text. An image-text matching model is trained based on a plurality of the sample texts and corresponding heat maps to obtain the multi-target image-text matching model. In the technical solution of the present disclosure, the problem of an inaccurate calculation result when there is a plurality of targets in an image may be solved by training the multi-target image-text matching model with the sample text and the corresponding heat map. Applying the multi-target image-text matching model to image-text retrieval may improve the accuracy of a retrieval result.

In a possible implementation, the second obtaining module 702 shown in FIG. 7 further includes an obtaining unit and a determination unit, wherein

the obtaining unit is configured to obtain a pre-trained image-text matching model; and

the determination unit is configured to obtain, for each training sample, the heat map corresponding to the sample text in the training sample based on the image-text matching model and the training sample.

In a possible implementation, the determination unit in the second obtaining module 702 is configured to:

for each training sample, input the training sample to the image-text matching model to obtain a similarity and a gradient that correspond to the training sample; and process the sample image in the training sample based on the similarity and the gradient that correspond to the training sample, to obtain the heat map corresponding to the sample text in the training sample.

In a possible implementation, the model training module 703 shown in FIG. 7 is configured to:

obtain a pre-trained image-text matching model; and

adjust model parameters of the image-text matching model based on the plurality of sample texts and the corresponding heat maps to obtain the multi-target image-text matching model.

In a possible implementation, the image-text matching model includes a pre-trained text encoder and a pre-trained image encoder.

The functions of the units, modules, or submodules in each apparatus of embodiments of the present disclosure can be referred to the corresponding descriptions in the embodiments of the above-described method for training a multi-target image-text matching model and are not repeated here.

FIG. 8 is a schematic diagram of an image-text retrieval apparatus according to an embodiment of the present disclosure. As shown in FIG. 8, the image-text retrieval apparatus may include:

an obtaining module 801 configured to obtain a retrieval text and a plurality of images;

a matching module 802 configured to input the retrieval text and the plurality of images to a multi-target image-text matching model to obtain similarities between the retrieval text and the plurality of images; and

a determination module 803 configured to determine a target image corresponding to the retrieval text according to the similarities between the retrieval text and the plurality of images,

wherein the multi-target image-text matching model is trained with the method for training a multi-target image-text matching model according to the embodiments of the present disclosure.

According to the image-text retrieval method provided in the embodiments of the present disclosure, using the pre-trained multi-target image-text matching model to calculate the similarity may solve the problem of an inaccurate calculation result when there is a plurality of targets in an image, and improve the accuracy of a retrieval result.

In a possible implementation, the image-text retrieval apparatus shown in FIG. 8 may further include a classification module configured to:

extract an image feature of each of the plurality of images through an image encoder of the multi-target image-text matching model, and classify the image feature of each image to obtain and store images of a plurality of classes.

In a possible implementation, the matching module 802 shown in FIG. 8 is configured to:

extract a text feature of the retrieval text through a text encoder of the multi-target image-text matching model;

determine, in the images of the plurality of classes, images of a target class corresponding to the retrieval text; and

obtain similarities between the retrieval text and each of the images of the target class through a similarity determination module of the multi-target image-text matching model.

The functions of the units, modules, or submodules in each apparatus of embodiments of the present disclosure can be referred to the corresponding descriptions in the embodiments of the above-described image-text retrieval method and are not repeated here.

In the technical solutions of the present disclosure, the acquisition, storage and application of the personal information of the user are in compliance with the provisions of relevant laws and regulations, and do not violate public order and good customs.

According to another aspect of the present disclosure, an electronic device is provided, including:

at least one processor; and

a memory in communicative connection with the at least one processor, wherein

the memory stores instructions executable by the at least one processor that, when executed by the at least one processor, cause the at least one processor to perform the method of any of the embodiments of the present disclosure.

According to another aspect of the present disclosure, there is provided a non-transitory computer-readable storage medium storing computer instructions, the computer instructions executed to cause a computer to perform the method of any of the embodiments of the present disclosure.

According to another aspect of the present disclosure, there is provided a computer program product including computer programs that, when executed by a processor, cause to implement the method of any of the embodiments of the present disclosure.

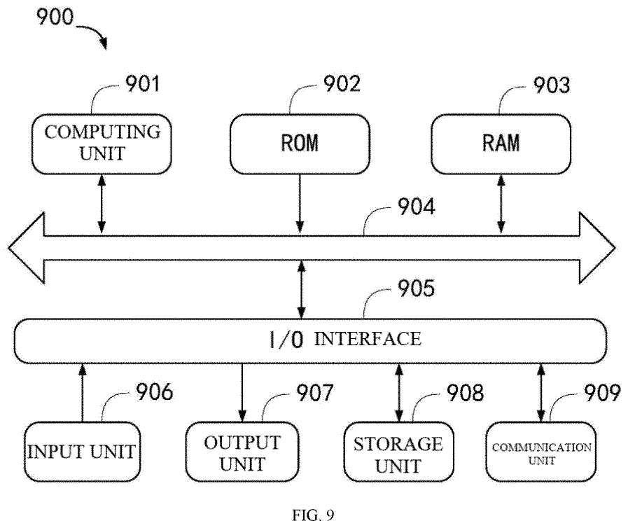

FIG. 9 is a schematic block diagram of an example electronic device 900 that may be used to implement the embodiments of the present disclosure. The electronic device is intended to represent various forms of digital computers, such as a laptop computer, a desktop computer, a workstation, a personal digital assistant, a server, a blade server, a mainframe computer, and other suitable computers. The electronic device may further represent various forms of mobile apparatuses, such as a personal digital assistant, a cellular phone, a smartphone, a wearable device, and other similar computing apparatuses. The components shown herein, their connections and relationships, and their functions are merely examples, and are not intended to limit the implementation of the present disclosure described and/or required herein.

As shown in FIG. 9, the device 900 includes a computing unit 901, which may perform various appropriate actions and processing according to computer programs stored in a read-only memory (ROM) 902 or computer programs loaded from a storage unit 908 to a random access memory (RAM) 903. The RAM 903 may further store various programs and information required for the operations of the device 900. The computing unit 901, the ROM 902, and the RAM 903 are connected to each other via a bus 904. An input/output (I/O) interface 905 is also connected to the bus 904.

A plurality of components in the device 900 are connected to the I/O interface 905, including: an input unit 906, such as a keyboard or a mouse; an output unit 907, such as various types of displays or speakers; a storage unit 908, such as a magnetic disk or an optical disc; and a communication unit 909, such as a network card, a modem, a wireless communication transceiver, etc. The communication unit 909 allows the device 900 to exchange information/data with other devices through a computer network such as the Internet, and/or various telecommunication networks.

The computing unit 901 may be various general-purpose and/or special-purpose processing components with processing and computing capabilities. Some examples of the computing unit 901 include, but are not limited to, a central processing unit (CPU), a graphics processing unit (GPU), various dedicated artificial intelligence (AI) computing chips, various computing units that run machine learning model algorithms, a digital signal processor (DSP), and any appropriate processor, controller, microcontroller, etc. The computing unit 901 performs the various methods and processing described above, for example, any method according to the embodiments of the present disclosure. For example, in some embodiments, the method according to the embodiments of the present disclosure may be implemented as computer software programs, which are tangibly included in a machine-readable medium, such as the storage unit 908. In some embodiments, a portion or all of the computer programs may be loaded and/or installed onto the device 900 via the ROM 902 and/or the communication unit 909. When the computer programs are loaded to the RAM 903 and executed by the computing unit 901, one or more steps of the method described above can be performed. Alternatively, in other embodiments, the computing unit 901 may be configured, in any other suitable manners (for example, by firmware), to perform the method according to the embodiments of the present disclosure.

Various implementations of the systems and technologies described herein above may be implemented in a digital electronic circuit system, an integrated circuit system, a field programmable gate array (FPGA), an application-specific integrated circuit (ASIC), an application-specific standard product (ASSP), a system-on-chip (SOC) system, a complex programmable logical device (CPLD), computer hardware, firmware, software, and/or a combination thereof. These various implementations may include implementing the systems and technologies in one or more computer programs, wherein the one or more computer programs may be executed and/or interpreted on a programmable system including at least one programmable processor. The programmable processor may be a dedicated or general-purpose programmable processor that can receive information and instructions from a storage system, at least one input apparatus, and at least one output apparatus, and transmit the information and instructions to the storage system, the at least one input apparatus, and the at least one output apparatus.

Program codes for implementing the method of the present disclosure may be written in any combination of one or more programming languages. These program codes may be provided to processors or controllers of the general-purpose computer, the special-purpose computer, or other programmable information processing apparatuses, such that when the program codes are executed by the processors or the controllers, the functions/operations specified in the flowcharts and/or block diagrams are implemented. The program codes may be completely executed on a machine, or partially executed on a machine, or may be, as an independent software package, partially executed on a machine and partially executed on a remote machine, or completely executed on a remote machine or a server.

In the context of the present disclosure, the machine-readable medium may be a tangible medium, which may include or store programs for use by an instruction execution system, apparatus, or device, or for use in combination with the instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof.

In order to provide interaction with a user, the systems and technologies described herein may be implemented on a computer which has: a display apparatus (for example, a cathode-ray tube (CRT) or a liquid crystal display (LCD) monitor) configured to display information to the user; and a keyboard and a pointing apparatus (for example, a mouse or a trackball) through which the user can provide an input to the computer. Other types of apparatuses can also be used to provide interaction with the user; for example, feedback provided to the user can be any form of sensory feedback (for example, visual feedback, auditory feedback, or tactile feedback), and an input from the user can be received in any form (including an acoustic input, a voice input, or a tactile input).

The systems and technologies described herein may be implemented in a computing system including a backend component (for example, as an information server), or a computing system including a middleware component (for example, an application server), or a computing system including a frontend component (for example, a user computer with a graphical user interface or a web browser through which the user can interact with the implementations of the systems and technologies described herein), or a computing system including any combination of the backend component, the middleware component, or the frontend component. The components of the system can be connected to each other through digital information communication (for example, a communications network) in any form or medium. Examples of the communication network include: a local area network (LAN), a wide area network (WAN), and the Internet.

A computer system may include a client and a server. The client and the server are generally far away from each other and usually interact through a communication network. A relationship between the client and the server is generated through computer programs running on respective computers and having a client-server relationship with each other. The server may be a cloud server, a server in a distributed system, or a server combined with a blockchain.

It should be understood that steps may be reordered, added, or deleted based on the various forms of procedures described above. For example, the steps described in the present disclosure may be performed in parallel, in order, or in a different order, provided that the desired result of the technical solutions disclosed in the present disclosure can be achieved, which is not limited herein.

The specific implementations described above do not limit the scope of protection of the present disclosure. It will be apparent for those skilled in the art that various modifications, combinations, sub-combinations, and replacements can be made based on design requirements and other factors. Any modifications, equivalent replacements, improvements, etc. within the spirit and principle of the present disclosure shall fall within the scope of protection of the present disclosure.

What is claimed is:

1. A method, comprising:
obtaining a plurality of training samples, wherein the plurality of training samples comprises sample pairs each including a sample image and a sample text, and the sample image comprises a plurality of targets;
obtaining, for each training sample of the plurality of training samples, a heat map corresponding to the sample text in the training sample, wherein the heat map represents a region of one of the plurality of the targets in the sample image that corresponds to the sample text; and
training an image-text matching model based on a plurality of the sample texts and the respective heat maps to obtain a multi-target image-text matching model.

2. The method according to claim 1, wherein obtaining, for each training sample of the plurality of training samples, the heat map corresponding to the sample text in the training sample comprises:
obtaining a pre-trained image-text matching model; and
obtaining, for each training sample of the plurality of training samples, the heat map corresponding to the sample text in the training sample based on the pre-trained image-text matching model and the training sample.

3. The method according to claim 2, wherein obtaining, for each training sample of the plurality of training samples, the heat map corresponding to the sample text in the training sample based on the pre-trained image-text matching model and the training sample comprises:
inputting, for each training sample of the plurality of training samples, the training sample to the pre-trained image-text matching model to obtain a similarity and a gradient that correspond to the training sample; and
processing the sample image in the training sample based on the similarity and the gradient that correspond to the training sample to obtain the heat map corresponding to the sample text in the training sample.

4. The method according to claim 1, wherein training the image-text matching model based on the plurality of the sample texts and the respective heat maps to obtain the multi-target image-text matching model comprises:
obtaining a pre-trained image-text matching model; and
adjusting model parameters of the pre-trained image-text matching model based on the plurality of the sample texts and the respective heat maps to obtain the multi-target image-text matching model.

5. The method according to claim 1, wherein the image-text matching model comprises a pre-trained text encoder and a pre-trained image encoder.

6. The method according to claim 1, further comprising:
obtaining a retrieval text and a plurality of images;
inputting the retrieval text and the plurality of images to the multi-target image-text matching model to obtain similarities between the retrieval text and the plurality of images; and
determining a target image corresponding to the retrieval text based on the similarities between the retrieval text and the plurality of images.

7. The method according to claim 6, wherein the method further comprises: after obtaining the plurality of images,
extracting an image feature of each of the plurality of images through an image encoder of the multi-target image-text matching model; and
classifying the image feature of each image to obtain and store the plurality of images of a plurality of classes.

8. The method according to claim 7, wherein inputting the retrieval text and the plurality of images to the multi-target image-text matching model to obtain the similarities between the retrieval text and the plurality of images comprises:
extracting a text feature of the retrieval text through a text encoder of the multi-target image-text matching model;
determining, in the plurality of images of the plurality of classes, one or more images of a target class corresponding to the retrieval text; and
obtaining the similarities between the retrieval text and each of the one or more images of the target class through a similarity determination module of the multi-target image-text matching model.

9. An electronic device, comprising:
at least one processor; and
a memory in communicative connection with the at least one processor, wherein
the memory stores instructions executable by the at least one processor that, when executed by the at least one processor, cause the at least one processor to:
obtain a plurality of training samples, wherein the plurality of training samples comprises sample pairs each including a sample image and a sample text, and the sample image comprises a plurality of targets;
obtain, for each training sample of the plurality of training samples, a heat map corresponding to the sample text in the training sample, wherein the heat map represents a region of one of the plurality of the targets in the sample image that corresponds to the sample text; and
train an image-text matching model based on a plurality of the sample texts and the respective heat maps to obtain a multi-target image-text matching model.

10. The electronic device according to claim 9, wherein obtaining, for each training sample of the plurality of training samples, the heat map corresponding to the sample text in the training sample comprises:
obtaining a pre-trained image-text matching model; and
obtaining, for each training sample of the plurality of training samples, the heat map corresponding to the sample text in the training sample based on the pre-trained image-text matching model and the training sample.

11. The electronic device according to claim 10, wherein obtaining, for each training sample of the plurality of training samples, the heat map corresponding to the sample text in the training sample based on the pre-trained image-text matching model and the training sample comprises:
inputting, for each training sample of the plurality of training samples, the training sample to the pre-trained image-text matching model to obtain a similarity and a gradient that correspond to the training sample; and
processing the sample image in the training sample based on the similarity and the gradient that correspond to the training sample to obtain the heat map corresponding to the sample text in the training sample.

12. The electronic device according to claim 9, wherein training the image-text matching model based on the plurality of the sample texts and the respective heat maps to obtain the multi-target image-text matching model comprises:
obtaining a pre-trained image-text matching model; and
adjusting model parameters of the pre-trained image-text matching model based on the plurality of the sample texts and the respective heat maps to obtain the multi-target image-text matching model.

13. The electronic device according to claim 9, wherein the image-text matching model comprises a pre-trained text encoder and a pre-trained image encoder.

14. The electronic device according to claim 9, wherein the instructions, when executed by the at least one processor, further cause the at least one processor to:
obtain a retrieval text and a plurality of images;
input the retrieval text and the plurality of images to the multi-target image-text matching model to obtain similarities between the retrieval text and the plurality of images; and
determine a target image corresponding to the retrieval text based on the similarities between the retrieval text and the plurality of images.

15. The electronic device according to claim 14, wherein the instructions, when executed by the at least one processor, further cause the at least one processor to:
extract an image feature of each of the plurality of images through an image encoder of the multi-target image-text matching model; and
classify the image feature of each image to obtain and store the plurality of images of a plurality of classes.

16. The electronic device according to claim 15, wherein inputting the retrieval text and the plurality of images to the multi-target image-text matching model to obtain the similarities between the retrieval text and the plurality of images comprises:
extracting a text feature of the retrieval text through a text encoder of the multi-target image-text matching model;
determining, in the plurality of images of the plurality of classes, one or more images of a target class corresponding to the retrieval text; and
obtaining the similarities between the retrieval text and each of the one or more images of the target class through a similarity determination module of the multi-target image-text matching model.

17. A non-transitory computer-readable storage medium storing computer instructions, wherein the computer instructions are executed to cause a computer to:
obtain a plurality of training samples, wherein the plurality of training samples comprises sample pairs each including a sample image and a sample text, and the sample image comprises a plurality of targets;
obtain, for each training sample of the plurality of training samples, a heat map corresponding to the sample text in the training sample, wherein the heat map represents a region of one of the plurality of the targets in the sample image that corresponds to the sample text; and
train an image-text matching model based on a plurality of the sample texts and the respective heat maps to obtain a multi-target image-text matching model.

18. The non-transitory computer-readable storage medium according to claim 17, wherein obtaining, for each training sample of the plurality of training samples, the heat map corresponding to the sample text in the training sample comprises:
obtaining a pre-trained image-text matching model; and
obtaining, for each training sample of the plurality of training samples, the heat map corresponding to the sample text in the training sample based on the pre-trained image-text matching model and the training sample.

19. The non-transitory computer-readable storage medium according to claim 18, wherein obtaining, for each training sample of the plurality of training samples, the heat map corresponding to the sample text in the training sample based on the pre-trained image-text matching model and the training sample comprises:
inputting, for each training sample of the plurality of training samples, the training sample to the pre-trained image-text matching model to obtain a similarity and a gradient that correspond to the training sample; and
processing the sample image in the training sample based on the similarity and the gradient that correspond to the training sample to obtain the heat map corresponding to the sample text in the training sample.

20. The non-transitory computer-readable storage medium according to claim 17, wherein the computer instructions are executed to further cause the computer to:
obtain a retrieval text and a plurality of images;
input the retrieval text and the plurality of images to the multi-target image-text matching model to obtain similarities between the retrieval text and the plurality of images; and
determine a target image corresponding to the retrieval text based on the similarities between the retrieval text and the plurality of images.
